(19) United States
(12) Patent Application Publication
(10) Pub. No.: US 2015/0264025 A1
(43) Pub. Date: Sep. 17, 2015

(54) PERSISTENT BOOKMARKLET AUTHORIZATION

(71) Applicant: Microsoft Corporation, Redmond, WA (US)

(72) Inventors: Scott Kurtzeborn, Seattle, WA (US); Lee Riefberg, Redmond, WA (US); Eleazar Vega-Gonzalez, Seattle, WA (US); Han Jung, Redmond, WA (US); Yan Lu, Redmond, WA (US); Ian Mikutel, Redmond, WA (US)

(73) Assignee: Microsoft Corporation, Redmond, WA (US)

(21) Appl. No.: 14/216,603

(22) Filed: Mar. 17, 2014

(51) Int. Cl. H04L 29/06; G06F 17/30

(52) U.S. Cl. CPC H04L 63/08; G06F 17/30893

(57) ABSTRACT

A browser application may provide one or more bookmarklets, or bookmarklets may be imported to the browser upon user action. Upon first time activation of the bookmarklet, the user may be authenticated and the bookmarklet authorized for that user and the client device. Using a bookmarklet identifier, the bookmarklet functionality may be persisted on the same client device without re-authorization indefinitely, for a predefined period, for a random period, or for a predefined number of uses allowing enhanced protection against malware that may attempt to access user resources through the bookmarklet.

### BACKGROUND

A bookmarklet is a bookmark stored in a web browser that contains one or more script commands to extend the browser's functionality. For example, a bookmarklet may allow the user to select text on a page, click the bookmarklet, and be presented with a search engine results page for the search term selected.

Bookmarklets are unobtrusive scripts stored as the URL of a bookmark in a web browser or as a hyperlink on a web page. Typical bookmarklets are designed to add one-click functionality to a browser or web page. When clicked, a bookmarklet may perform a function, one of a wide variety such as a search query, image extraction, text extraction, or similar ones. An example of bookmarklets is a clipper, which is a tool that generally runs on a web browser to enable “clipping” of content from a web page displayed by the web browser. In this context, clipping refers to the extraction or capture of the hypertext markup language (HTML), text and/or graphic elements from a web page to facilitate the storage of content for future access (e.g., reading, annotating, collecting) when not on the web site, and even off-line.

A web clipper may be associated with a specific destination application or storage. Functionality of a web clipper may often be provided by a developer of the destination application as a plug-in or add-on for a web browser. The user may be enabled to insert content from a web page easily into a document hosted by a client application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to persistence of a bookmarklet through authentication of a user and authorization of the bookmarklet upon first activation. According to some examples, a bookmarklet provided through a browser or similar application on a client device may trigger authentication of a user activating it for the first time. Upon user authentication through one or more techniques, the bookmarklet may be authorized and its functionality made available. A bookmarklet identifier may be used to persist the bookmarklet functionality without re-authorization through the same instance of the browser or through different instances on the same client device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a browser application with a bookmarklet control such as a button to activate and authorize the bookmarklet;

FIG. 2 illustrates an example of authorization of a bookmarklet following authentication of a user through a bookmarklet button on a browser application user interface;

FIG. 3 illustrates an example of authorization of a content-related bookmarklet following authentication of a user through selection of a portion of displayed content on a browser application user interface;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of persisting a bookmarklet through user authentication and bookmarklet authorization, according to embodiments.

### DETAILED DESCRIPTION

As briefly described above, a browser application may provide one or more bookmarklets or bookmarklets may be imported to the browser upon user action. Upon first time activation of the bookmarklet, the user may be authenticated and the bookmarklet authorized for that user and the client device. Using a bookmarklet identifier, the bookmarklet functionality may be persisted on the same client device without re-authorization indefinitely, for a predefined period, for a random period, or for a predefined number of uses allowing enhanced protection against malware that may attempt to access user resources through the bookmarklet.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to authorize a bookmarklet in a persistent manner. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

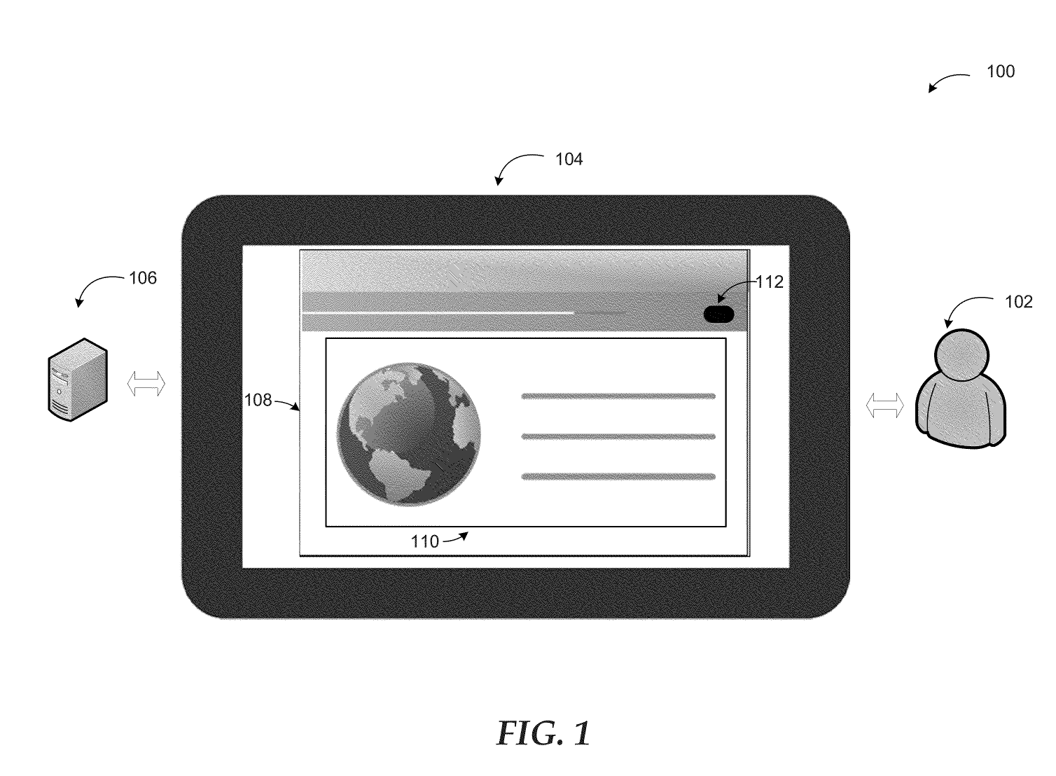

FIG. 1 illustrates a browser application with a bookmarklet control such as a button to activate and authorize the bookmarklet, according to some embodiments described herein. While diagram 100 shows a tablet device and a browser application as example environments for persistent bookmarklet authorization, embodiments may be implemented in any computing environment and any client application that allows use of bookmarklet functionality.

According to some embodiments, a browser 108 executed on a client device 104 may receive content from a third party provider such a server 106 and display The server 106 may provide content such as documents, web pages, video, audio, and similar media for consumption by one or more applications executing in client devices or services provided by other servers. In an example scenario, a web page displayed on the client device 104 may include textual, graphic, audio, and/or video content.

Various bookmarklets may also be provided through the browser 108 to allow specific functionality associated with the displayed content such as performing searches, providing translations, mapping functionality, and content capture, among other functions. Bookmarklets may be activated through specific controls such as button 112 on the browser or other methods such as drop-down menus, performance of a specific action (e.g., selection of a portion of displayed content), etc.

In an example scenario, a user 102 may select a portion of the content 110 displayed by the browser 108. The portion of content 110 may be captured by a bookmarklet (also referred to as a “clipper”) as a clip to be stored and used for a variety of purposes. As the bookmarklet captures the portion of the content 110 as rendered by the browser 108, executable content associated with the portion of the content 110 may also be captured. The executable content may present security risks associated with execution of a malicious script since content displayed by the browser may come from a variety of sources.

Embodiments may prevent capture and execution of malicious content by the bookmarklet. A bookmarklet identifier stored, for example, as a cookie may be used in a combination process of authenticating the user and authorizing the bookmarklet such that the bookmarklet can be used repeatedly on the same client device without re-authorization.

Embodiments are not limited to an authentication and authorization scheme of the bookmarklet through a bookmarklet identifier. Other mechanisms may also be used to authorize the bookmarklet persistently employing the principles described herein. A cookie based mechanism may alternatively be used to authorize the bookmarklet. A cookie maybe associated with a user account that is validated against a stored user accounts within a trusted user account data store. The cookie may be used to authorize the bookmarklet and allow persistent use on the same client device.

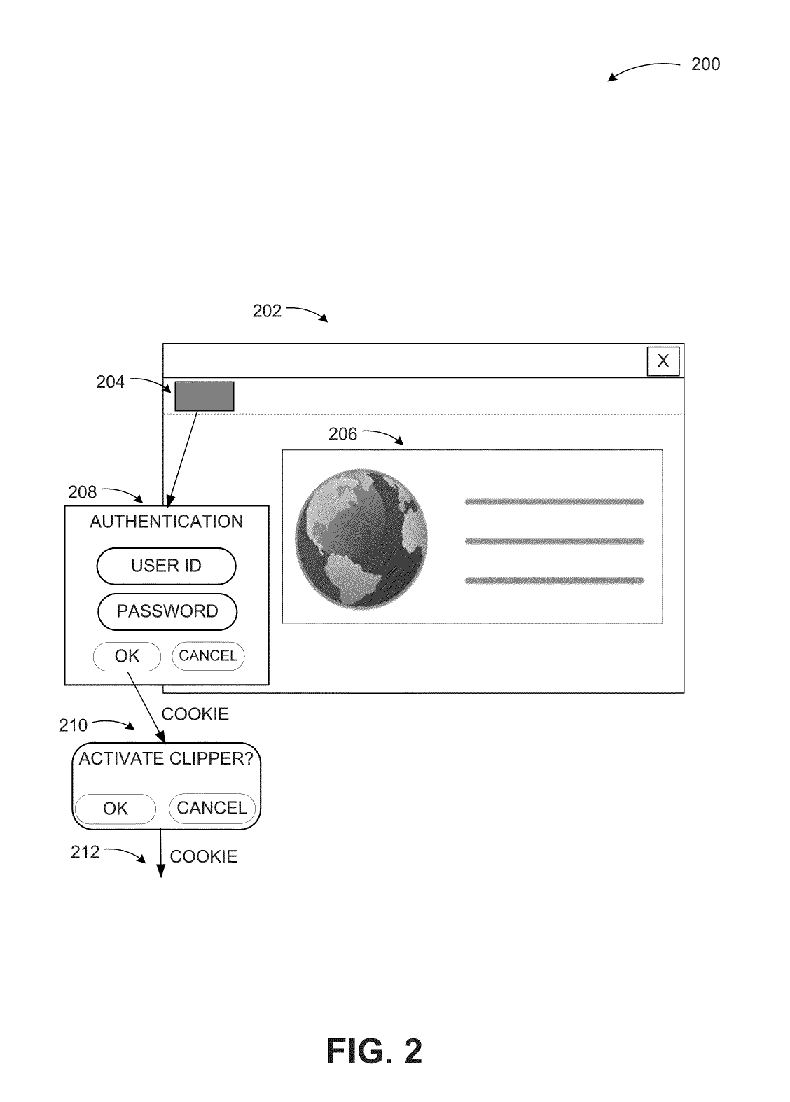

FIG. 2 illustrates an example of authorization of a bookmarklet following authentication of a user through a bookmarklet button on a browser application user interface, according to some embodiments discussed herein.

As illustrated in diagram 200, a browser application 202 may provide one or more bookmarklets, which may be activated through dedicated controls such as button 204. The bookmarklets may provide a range of functionality associated with the displayed content 206 such as capture of content portions for storage or otherwise consumption. To prevent security concerns associated with malicious executables that may be captured by a bookmarklet along with a portion of the content, the bookmarklet may be persistently authorized through a user authentication and bookmarklet authorization process using a bookmarklet identifier.

As shown in diagram 200, a user may activate a bookmarklet through button 204 to perform an action associated with the displayed content 206. If this is the first activation of the bookmarklet, an authentication user interface 208 may be displayed for the user to authenticate themselves. As the user authenticates themselves, a bookmarklet identifier may be generated or retrieved from a local store and passed on to a next step in the process, where an authorization user interface 210 may be displayed to confirm the user's intent to activate the bookmarklet. Upon affirmative response by the user, the bookmarklet identifier may be used to persist the authorization of the bookmarklet, for example, in form of a cookie 212. Thus, after the first use, the user may activate and use the bookmarklet repeatedly on the same instance or on different instances of the browser application 202.

The persistence of the bookmarklet's authorization may be indefinite, for a predefined period, for a randomly selected period, or for a number of uses to provide additional security against malware. According to some embodiments, the authentication of the user may take many forms such as capture of user credentials including a user name, a password, a biological identifier, a secure token, and similar ones to authenticate the user. In response to validating the user against stored user credentials (or accounts) within a trusted user account data store, the user account may be associated with the bookmarklet identifier to authorize the bookmarklet. In some examples, the bookmarklet may be processed in a relay page that disallows rendering of frames to prevent execution of a malicious script potentially embedded within the content.

The bookmarklet identifier may be stored as a variable within a script code of the bookmarklet. The bookmarklet identifier may be stored as a secret. The bookmarklet identifier may also be stored as a secret from a third party provider hosting the content.

In some examples, upon determining that the bookmarklet lacks the authorized status, the authentication user interface (UI) may be presented to authenticate the user (e.g., first use). Following the authorization, the bookmarklet's authorization status may be determined based on the identifier (e.g., cookie 212) and the bookmarklet may be allowed to be activated by the browser application 202.

The bookmarklet identifier and a user account used to authorize the bookmarklet may be stored in a trusted cloud storage, for example. Alternatively, the bookmarklet and the user information may be stored as a cookie in the browser application.

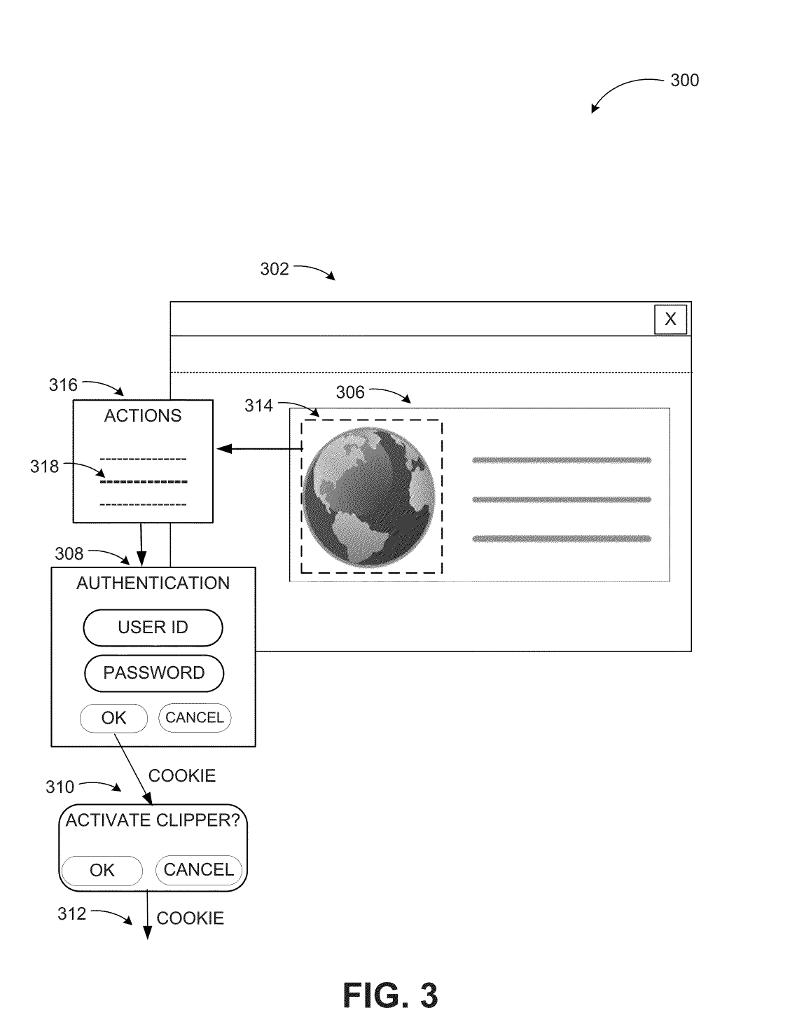

FIG. 3 illustrates an example of authorization of a content-related bookmarklet following authentication of a user through selection of a portion of displayed content on a browser application user interface, according to some example embodiments described herein.

Diagram 300 shows authorization of a bookmarklet similar to the process discussed in FIG. 2. The example scenario shown in diagram 300 may include a clipper bookmarklet that may capture selected content on a web page and enable storage or other use of the captured content. Instead of being activated by a dedicated control on the browser 302, the bookmarklet may be activated through a menu of actions 316, which may be displayed upon detection of selection 314 of a portion of displayed content 316. One of the selectable items on the menu of actions 316 may be clipper activation 318.

Upon selection of the clipper activation 318, the user authentication user interface 308 may be displayed. Following authentication of the user, authorization user interface 310 may be displayed and the authorization of the clipper may be persisted through a clipper identifier, which may be numeric or alphanumeric, for example, in form of a cookie stored at the browser 302. The clipper identifier may be generated at the time of activation or a pre-assigned identifier may be used. In the latter case, the identifier may be generated by a trusted third party, by the content provider, or by the bookmarklet (clipper) source.

The example applications, devices, and modules, depicted in FIGS. 1-3 are provided for illustration purposes only. Embodiments are not limited to persistent authorization of a bookmarklet as shown in the example diagrams, and may be implemented using other engines, client applications, service providers, and modules employing the principles described herein.

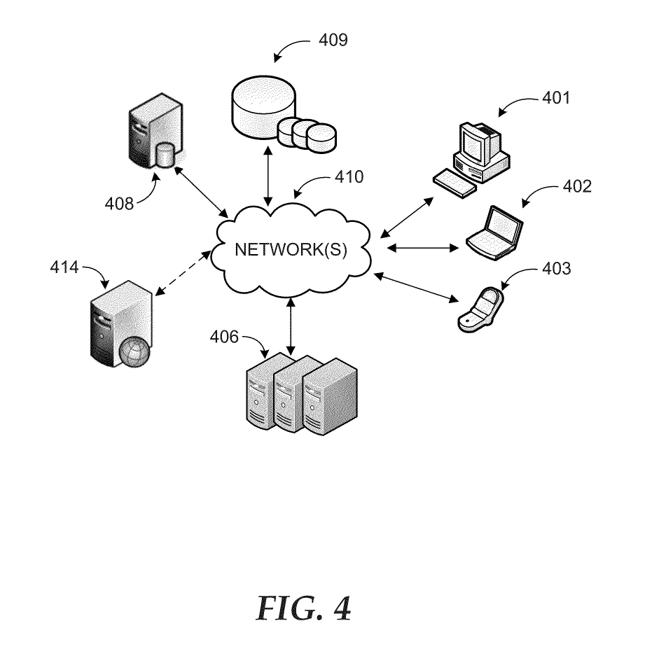

FIG. 4 is an example networked environment, where embodiments may be implemented. In addition to locally installed applications, a browser application may also be employed in conjunction with hosted applications and services that may be implemented via software executed over one or more servers 406 or individual server 408. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 are used to access the functionality provided by the hosted service or application. One or more of the servers 406 or server 408 may be used to persistently authorize a bookmarklet. Relevant data may be stored in one or more data stores (e.g. data store 409), which may be managed by any one of the servers 406 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to authorize a bookmarklet in a persistent manner. Furthermore, the networked environments discussed in FIG. 4 are for illustration purposes only. Embodiments are not limited to the example applications, modules, or processes.

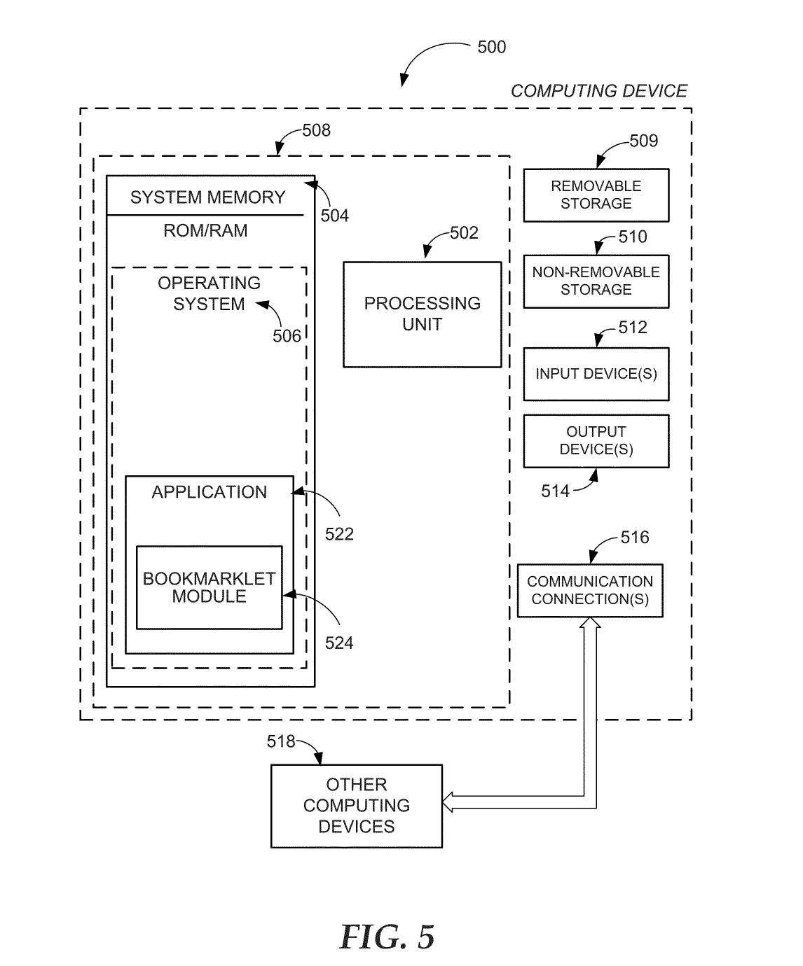

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any touch and/or gesture enabled device in stationary, mobile, or other form such as the example devices discussed in conjunction with FIGS. 1-3 and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as an application 522 and a bookmarklet module 524.

The bookmarklet module 524 (a script) may operate in conjunction with the operating system 506 or the application 522 to provide bookmarklet functionality associated with content delivered by the application 522 (e.g., browser application). The bookmarklet may be authorized through authentication of the user upon first time activation and allowed to be used without re-authorization on the same machine. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 515 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

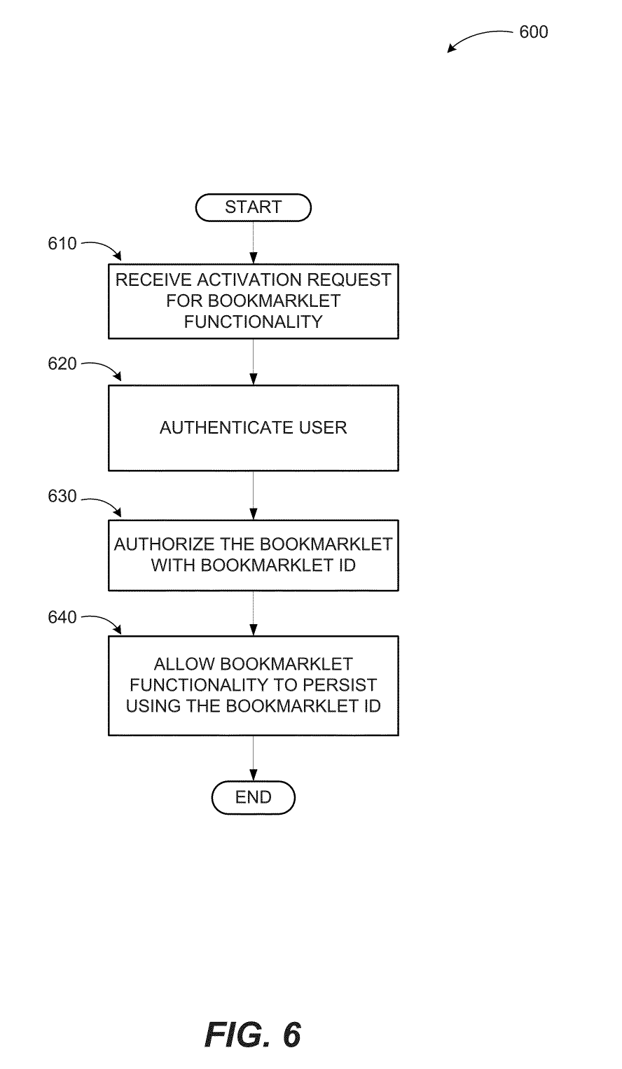

FIG. 6 illustrates a logic flow diagram for a process of persistently authorizing a bookmarklet, according to embodiments. Process 600 may be implemented as part of a browser application or an operating system.

Process 600 begins with operation 610, “RECEIVE ACTIVATION REQUEST FOR BOOKMARKLET FUNCTIONALITY,” where the bookmarklet may be activated for the first time through activation of a dedicated control or selection of a portion of displayed content, for example.

Operation 610 is followed by operation 620, “AUTHENTICATE THE USER” where the user may be authenticated through a variety of methods. The authentication may be associated with a bookmarklet identifier.

Operation 620 is followed by operation 630, “AUTHORIZE THE BOOKMARKLET WITH BOOKMARKLET ID,” where the bookmarklet may be authorized for the authenticated user on the computing device and the bookmarklet functionality allowed to be used.

Operation 630 is followed by operation 640, “ALLOW BOOKMARKLET FUNCTIONALITY TO PERSIST USING THE BOOKMARKLET ID,” where the bookmarklet's authorization may be persisted such that the bookmarklet can be used on the same instance or on different instances of the browser (on the same machine) indefinitely, for a predefined period, for a randomly selected period, or for a predefined number of uses.

The operations included in process 600 are for illustration purposes. Persistent authorization of a bookmarklet, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to authorize a bookmarklet persistently, the method comprising:
receiving an activation request for the bookmarklet;
authenticating a user submitting the request; and
authorizing the bookmarklet based on the authentication such that bookmarklet functionality is provided for repeated use without re-authorization.

2. The method of claim 1, wherein receiving the activation request for the bookmarklet comprises:
detecting activation of a dedicated control on a user interface of a browser application hosting the bookmarklet.

3. The method of claim 1, wherein receiving the activation request for the bookmarklet comprises:
detecting a selection of a portion of displayed content on a user interface of a browser application hosting the bookmarklet.

4. The method of claim 3, further comprising:
enabling capture of the portion of the displayed content upon authorization of the bookmarklet.

5. The method of claim 1, further comprising:
employing a bookmarklet identifier to persist the authorization of the bookmarklet.

6. The method of claim 5, further comprising:
storing the bookmarklet identifier as a variable within a script component of the bookmarklet.

7. The method of claim 5, further comprising:
storing the bookmarklet identifier as a secret.

8. The method of claim 5, further comprising:
storing the bookmarklet identifier in the cloud; and
enabling look-up of the stored identifier for subsequent activations of the bookmarklet.

9. The method of claim 1, further comprising:
employing a first cookie to indicate authenticated status of the user and a second cookie to indicate authorized status of the bookmarklet.

10. The method of claim 1, wherein authenticating the user comprises:
capturing the one or more user credentials including one or more from a set of: a user name, a password, a biological identifier, and a secure token to validate the user against stored users within a trusted user data store.

11. The method of claim 1, further comprising:
providing an authentication user interface (UI) to authenticate the user and an authorization UI to authorize the bookmarklet, wherein the authentication UI and the authorization UI are not frameable.

12. A computing device to authorize a bookmarklet persistently, the computing device comprising:
a memory;
a processor coupled to the memory, the processor executing an application that includes one or more bookmarklets, wherein the application is configured to:
receive an activation request for the bookmarklet;
authenticate a user submitting the request; and
authorize the bookmarklet based on the authentication employing a bookmarklet identifier such that bookmarklet functionality is provided for repeated use without re-authorization.

13. The computing device of claim 12, wherein the bookmarklet identifier is stored as a variable within a script component of the bookmarklet, as a secret, or in the cloud.

14. The computing device of claim 12, wherein the bookmarklet's authorization is persisted for a predefined period, indefinitely, for a randomly selected period, for a predefined number of activations, or for a randomly selected number of activations.

15. The computing device of claim 12, wherein the authorization of the bookmarklet is persisted for a same instance of the application or for different instances of the application on the same computing device.

16. The computing device of claim 12, wherein bookmarklet identifier is generated at the time of authorization.

17. The computing device of claim 12, wherein the bookmarklet identifier is downloaded to the application along with the bookmarklet.

18. A computer-readable memory device with instructions stored thereon to authorize a bookmarklet persistently, the instructions including:
receiving an activation request for the bookmarklet by detecting a selection of a portion of displayed content on a user interface of a browser application hosting the bookmarklet;
authenticating a user submitting the request; and
authorizing the bookmarklet employing a bookmarklet identifier based on the authentication such that bookmarklet functionality is provided for repeated use without re-authorization.

19. The computer-readable memory device of claim 18, wherein the bookmarklet is configured to capture the selected portion of the displayed content.

20. The computer-readable memory device of claim 19, wherein the bookmarklet identifier is stored as part of a cookie associated with the browser application.
